(19) United States
(12) Patent Application Publication
(10) Pub. No.: US 2002/0057080 A1
(43) Pub. Date: May 16, 2002

(54) Optimized digital regulation of switching power supply

(75) Inventors: Mark D. Telefus, Orinda, CA (US); Dickson T. Wong, Burlingame, CA (US); Charles R. Geber, Woodside, CA (US); Mark Muegge, Cupertino, CA (US)

Correspondence Address: LYON & LYON LLP, 633 WEST FIFTH STREET, SUITE 4700, LOS ANGELES, CA, 90071, US

(73) Assignee: iWatt

(21) Appl. No.: 09/970,849

(22) Filed: Oct. 3, 2001

Related U.S. Application Data
(63) Continuation-in-part of application No. 09/679,949, filed on Oct. 4, 2000.
Application No. 09/679,949 is a continuation-in-part of application No. 09/585,928, filed on Jun. 2, 2000.

(51) Int. Cl. G05F 1/40

(52) U.S. Cl. 323/283

(57) ABSTRACT

A digitally controlled, transformer-coupled switching power supply for conversion of power between a source and a load includes a power switch that, when coupled to the source and cycled ON and OFF by a controller, supplies a pulse of power to the load. Control circuitry for the power converter includes a pulse generator for generating switch activation pulses to cycle the power switch, each switch activation pulse produced by the pulse generator defining a new switching cycle. A pulse rate controller is coupled to the pulse generator for regulating an output voltage at the load by selectively allowing, on a pulse by pulse basis, switch activation pulses to cycle the power switch. A pulse optimizer is coupled to the pulse generator, the pulse optimizer controlling one or both of (1) when the pulse generator generates a respective switch activation pulse to initiate a new switching cycle in order to minimize converter losses by effecting zero-voltage switching across the transformer, and (2) the width of the switch activation pulses in order to maintain constant primary side peak current, regardless of variations in input line voltage.

### RELATED APPLICATION DATA

This application is a continuation-in-part of patent application Ser. No. 09/279,949, filed Oct. 4, 2000, which is a continuation-in-part of patent application Ser. No. 09/585,928, filed Jun. 2, 2000, now U.S. Pat. No. 6,275,018.

### FIELD OF INVENTION

This invention pertains generally to the field of power conversion and, more particularly, to digitally controlled power supplies.

### BACKGROUND

Compact and efficient power supplies are an increasing concern to users and manufacturers of electronics. Pulse width modulated (PWM) switching power supplies offer both compactness and efficiency in a number of different topologies, which can be placed in two main categories: isolated switching power supplies and non-isolated switching power supplies. In a non-isolated switching power supply, such as a buck (reducing voltage) or boost (increasing voltage) power supply, the power output is not isolated from the power input. Isolated power supplies, such as a flyback or forward switching power supplies, have a power output that is isolated from the power input through a transformer. In either type of power converter, however, typical control systems use a pulse-width-modulator to control the duty cycle of one or more power switches in the converter.

Consider, for example, the flyback power supply of FIG. 1, which includes a power switch Q1, typically a metal oxide semiconductor field effect transistor (MOSFET) coupled to the primary winding of a power transformer T1. A secondary diode D1 and storage capacitor C1 are coupled to the secondary winding of the power transformer T1. A control system for controlling the power supply includes a PWM controller 105, which alternately provides a switch activation pulse to cycle (i.e., turn ON and OFF) the power switch Q1. A feedback circuit 110, coupled to the PWM controller 105, receives a feedback signal corresponding to an output voltage, which changes with changes in both input line voltage and output load conditions. An oscillator (not shown) included in the PWM controller 105 sets the operating frequency of the power switch Q1, while a pulse-width modulator adjusts the duty cycle of the power switch Q1 in response to changes in the feedback signal. The frequency of the oscillator in PWM power supply controllers is typically relatively low, e.g., in the range of 50 KHz.

The relationship between the input voltage, V_{IN}, and the output voltage V_{OUT} for the power supply of FIG. 1 can be approximated as

V_{OUT}=(V_{IN}*Nₛ/Nₚ)*D/(1−D), with D=(T−t_{OFF})/ T,

where Nₚ is the number of turns on the primary winding, Nₛ is the number of turns on the secondary winding, D is the switching duty cycle, T is the switching period, and t_{OFF} is the off time of the power switch Q1. Thus, the off time, t_{OFF} and the on time, t_{ON} of the power switch Q1 (where t_{OFF}+t_{ON}=T) define a power switching cycle, or output power pulse, which is reflected in the value of the output voltage V_{OUT} in the above equation.

Similarly, the output voltage of a transformer-coupled forward power supply can be determined using the equation:

V_{OUT}=(V_{IN}*Nₛ/Nₚ)*D

Whether forward or flyback, the output power pulse received at the secondary side of the converter with each switching cycle is regulated, because the output power pulse characteristics have a direct relationship to the output voltage. This relationship between the characteristics of a single power cycle and the output voltage is generic to PWM controlled switching power supplies, regardless of whether the power supply is transformer coupled (isolated) or direct coupled (non-isolated).

FIG. 2 is a more general view of a transformer-coupled switching power supply, with the power switch Q1, transformer and secondary components simplified as a “power conversion stage” 205. The power stage 205 is controlled by PWM control circuitry indicated generally as controller 200, which includes a PWM controller 220 and a feedback circuit 210. The feedback signal line is shown in this case as a current sense on the output of the power switch Q1, and a connection to the output voltage of the power converter, input to a summing circuit 215.

A fundamental problem with PWM control is that the widths of the switch activation pulses can vary widely with changes in the input line voltage and output load conditions. Optimum converter efficiency is achieved only at a single operating point (i.e., input line and output load condition), where the output power pulse width and/or switching frequency happens to be well matched to the particular power conversion stage. Because output power pulses are directly coupled to output voltage regulation, optimization over a wide operating range using PWM control is not possible to achieve, without degrading output regulation performance.

### SUMMARY OF INVENTION

A controller for controlling a power supply for conversion of power between a source and a load, the power supply including a power switch that, when coupled to the source and cycled ON and OFF, supplies a pulse of power to the load. The controller includes pulse generation circuitry for generating switch activation pulses to cycle the power switch, each switch activation pulse produced by the pulse generator defining a new switching cycle. The controller further includes pulse optimization circuitry coupled to the pulse generation circuitry for controlling one or both of (1) when a switch activation pulse is generated to initiate a new switching cycle, and (2) the width of the switch activation pulse. Pulse rate control circuitry coupled to the pulse generation circuitry regulates an output voltage at the load by selectively allowing switch activation pulses to cycle the power switch.

In one embodiment, the pulse optimization circuitry causes a switch activation pulse to be generated to initiate a new switching cycle when the primary side voltage is approximately zero.

In one embodiment, the pulse optimization circuitry further controls a width of a switch activation pulse for a present switching cycle based on a primary side current during a previous switching cycle. In one embodiment, the pulse optimization circuitry determines a width of a switch activation pulse for a present switching cycle based on a power switch ON time needed to reach a primary side peak current during a previous switching cycle. Because the source typically has a variable input line voltage, embodiments include those where the primary side peak current is constant for all input voltages, and those where wherein the primary side peak current varies in relation to ranges of the input voltage.

In one embodiment, the controller includes a a first pulse generator for generating switch activation power pulses for cycling the power switch, wherein the power switch, when cycled ON and OFF by a power pulse, supplies a substantial pulse of power to the load. A second pulse generator for generating switch activation sense pulses for cycling the power switch, wherein the power switch, when cycled ON and OFF by a sense pulse, supplies a an insubstantial pulse of power to the load. The first and second pulse generators generating respective power and sense pulses at a same frequency, the production of a respective pulse by the first and second pulse generators defining a new switching cycle. Pulse optimization circuitry coupled to the first and second pulse generators, the pulse optimization circuitry controlling when the first and second pulse generators generate respective power and sense pulses to initiate a switching cycle.

Power pulses, in this embodiment, are used to effect the transfer of energy across the power stage 405 to the load. Sense pulses are much smaller pulses used mostly to perform primary-only monitoring of the output voltage at the load. For example, in one embodiment, sense pulses are one-forth the duration of power pulses and, thus, provide one-forth the amount of power to the load. Thus, overall output voltage regulation is provided by controlling the number and mix of power and sense pulses that cycle the power switch over time. The ON and OFF times of the respective power and sense pulses are controlled by pulse optimization circuitry maintain zero voltage switching and fixed primary side peak current for each switching cycle, regardless of changes in input line or output load conditions.

Other aspects and features of the invention will become apparent from the following detailed description of the various embodiments and appended claims, when considered in conjunction with the accompanying drawings.

### BRIEF DESCRIPTION OF DRAWINGS

Preferred embodiments of the present inventions taught herein are illustrated by way of example, and not by way of limitation, in the Figures of the accompanying drawings, in which:

FIG. 1 is a functional and schematic block diagram illustrating a prior art PWM control system controlling a flyback power converter.

FIG. 2 is a functional block diagram illustrating a prior art PWM control system for controlling a generic switching converter “power stage”.

FIG. 3 is a functional block diagram illustrating a transformer-isolated power stage having a power switch controlled by a digital control system including a pulse generator for generating switch activation pulses for selectively cycling the power switch.

FIG. 4 is a functional block diagram illustrating a further transformer-isolated power stage, such as a flyback converter, having a power switch controlled by a digital control system including first and second pulse generators for generating respective power and sense pulses for selectively cycling the power switch.

FIG. 5 shows selected control and output waveforms of the control system of FIG. 4 controlling a flyback converter power stage.

FIG. 6 shows selected control and output waveforms of the control system and power stage of FIG. 3, according to one embodiment of a pulse rate control algorithm.

FIG. 7 is a flow chart of one embodiment of a pulse rate control algorithm implemented by the control system of FIG. 4.

FIG. 8 is a functional block diagram illustrating a still further transformer-isolated power stage, such as a flyback converter, having a power switch controlled by a digital control system including optimized first and second pulse generators for generating respective optimized power and sense pulses for selectively cycling the power switch.

FIGS. 9 and 10 show primary voltage and secondary current waveforms of a power supply cycled by the control system of FIG. 8.

FIG. 11 is a functional block diagram illustrating an exemplary optimized digital control system for controlling a transformer-isolated power converter.

### DETAILED DESCRIPTION OF PREFERRED EMBODIMENTS

Those skilled in the art will appreciate that the power converter control systems disclosed and described herein may implemented with analog and/or digital circuitry, which may include various logic circuits and/or a microprocessor, along with appropriate software or firmware, to achieve the described features and functions. Those skilled in the art will further appreciate that the control systems disclosed and described herein may operate with any isolated switching power controller topology for optimizing converter efficiency, and may also be used to improve efficiency of certain non-isolated topologies.

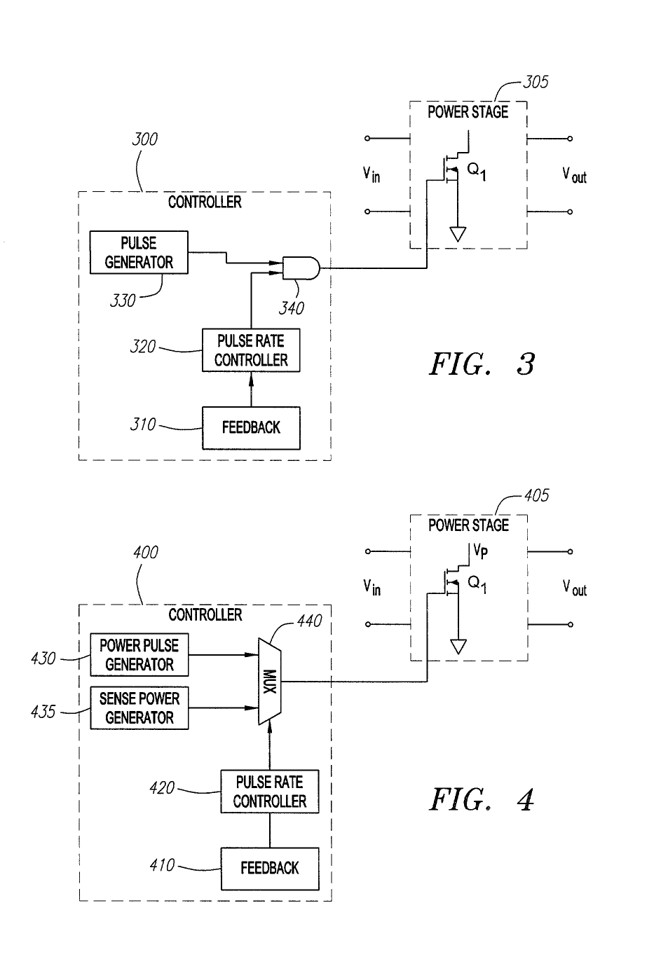

FIG. 3 depicts a generic transformer-isolated power stage 305. The power stage 305 includes a power MOSFET switch Q1 having an activation gate that is cycled ON and OFF by a controller 300. The controller 300 includes a pulse generator 330 for generating switch activation pulses at a relatively high frequency (e.g., 100 KHz to 1 MHz) to cycle the power switch Q1 ON and OFF, with each switch activation pulse produced by the pulse generator 330 defining a new switching cycle. The switch activation pulses from the pulse generator 330 are input into a gating mux 340, along with a control signal provided from a pulse rate controller 320. The controller 300 regulates an output voltage at the load by selectively allowing for each switching cycle, i.e., on a pulse-by-pulse basis, individual ones of the switch activation pulses to cycle the power switch Q1 based, at least in part, on a feedback signal 310 corresponding to the output voltage.

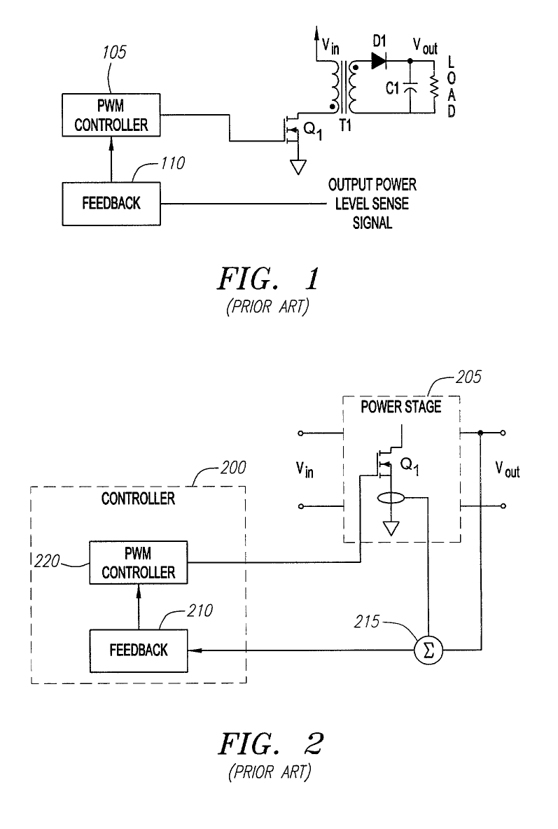

In particular, regulation of the output voltage is provided by controlling the number of pulses of power appearing at the output of the power stage over time by controlling the number of switch activation pulses from the pulse generator 330 that activate the power switch Q1. In this context, the controller 300 is providing digital regulation of the power stage 305. Notably, unlike the PWM control technique discussed above in conjunction with the prior art power supplies of FIGS. 1 and 2, the switch activation pulse duty cycle and frequency are not based on the output voltage.

In one embodiment, the feedback signal 310 is a binary signal, i.e., comprising a one (“high”) or a zero (“low”), representing or otherwise corresponding to whether the output voltage during the immediately preceding switching cycle is greater than, or less than, respectively, a desired output voltage. For example, the feedback signal may be derived by comparing the actual (sensed) output voltage to a reference representative of a desired output voltage. In one embodiment, the output voltage is sensed via an auxiliary secondary transformer winding that is coupled to the primary-side ground plane. In another embodiment, wherein the power stage 305 is a transformer-coupled flyback converter, a primary side voltage is sampled at the input (drain) of the power switch Q1 at a point during the switching cycle when it is representative of the output voltage. Notably, primary-side only feedback can be a preferred method for obtaining information from the output side of a flyback converter for the purpose of regulation. Compared to secondary feedback, with costly opto-isolator circuits and the attendant demands on PCB layout, primary-only feedback offers the potential of less-expensive, slimmer power supplies for consumer electronic products.

In one embodiment, illustrated in FIG. 6, the control signal input into the gating mux 340 by the pulse rate controller 320 is, in effect, the same binary (high or low) feedback signal 310 from an immediately preceding switching cycle, although possibly buffered and/or inverted for proper timing. In this case, if the feedback signal 310 for a given switching cycle n indicates the output voltage is less than a desired level, the control signal causes the gating mux 340 to allow a switch activation pulse to cycle the power switch Q1 in the following switching cycle n+1. Similarly, if the feedback signal 310 for a given switching cycle n indicates the output voltage Vₒ is greater than a desired level, the control signal causes the gating mux 340 to gate (prevent) the switch activation pulse from cycling the power switch Q1 for cycle n+1.

Notably, while the gating mux 340 is illustrated as an AND gate, it will be appreciated that another type of gate, including one or more logic gates, may be used. Also, it will be appreciated by those skilled in the art that the particular functional circuit elements of the controller 300, i.e., feedback signal 310, pulse rate controller 320, pulse generator 330, and gating mux 340, may be implemented in a single circuit, separate circuits, or circuits comprising sub-combinations thereof. For example, in one embodiment, the function of pulse generation and pulse gating may be combined, such that the pulse rate control algorithm dictates whether a switch activation pulse, or no pulse, is generated for a given switching cycle. In this embodiment, no actual gating of the switch activation pulses is required. Further, the power switch Q1 may alternately be integral to the controller 300 instead of the power stage 305, separate from both, or included in a fully integrated power converter and control system. Thus, the circuit elements of the described embodiments are not to be restricted in the appended claims to require that the various functions be provided by separate circuits.

FIG. 4 depicts a further generic transformer-isolated power stage 405, which is preferably a flyback converter. The power stage 405 includes a MOSFET power switch Q1 having an activation gate that is cycled ON and OFF by a controller 400. The controller 400 includes a first pulse generator 430 for producing switch activation “power pulses” for cycling the power switch Q1, wherein the power switch Q1, when cycled ON and OFF by a power pulse, supplies a substantial pulse of power to the load. The controller 400 also includes a second pulse generator 435 for producing switch activation “sense pulses,” which are substantially shorter in duration than the power pulses produced by the first pulse generator 430, for cycling the power switch Q1. The power switch Q1, when cycled ON and OFF by a sense pulse, supplies a much small, “insubstantial” pulse of power to the load. The first and second pulse generators 430 and 435 produce the respective power and sense pulses at a same, relatively high frequency (e.g., 100 KHz to 1 MHz), wherein the production of a respective pulse by the first and second pulse generators initiates a new switching cycle for the power stage 405.

The respective power and sense pulses are input into a gating mux 440, where, for each switching cycle, a power pulse, sense pulse, or neither, is allowed to cycle the power switch Q1, based on a control signal from a pulse rate controller 420 that is also input into the gating mux 440. Notably, power pulses, in this embodiment, are used to effect the transfer of energy across the power stage 405 to the load. Sense pulses are much smaller pulses used mostly to perform primary-only monitoring of the output voltage at the load. For example, in one embodiment, sense pulses are one-forth the duration of power pulses and, thus, provide one-forth the amount of power to the load. Thus, overall output voltage regulation is provided by controlling the number and mix of power and sense pulses that cycle the power switch Q1 over time.

The control signal from the pulse controller 420 is based on a pulse control algorithm, which may be hardware or software implemented in the pulse rate controller, e.g., by a simple or more complex state machine. In most embodiments, the pulse control algorithm will be based, at least in part, on a feedback signal 410 corresponding to the output voltage. The feedback signal is preferably a binary feedback signal derived in the same manner as above-described feedback signal 310.

In one embodiment, the control signal from the pulse rate controller 420 is, in effect, the same binary feedback signal 410 from an immediately preceding switching cycle (although possibly buffered and/or inverted for proper timing). If the feedback signal 410 for a given switching cycle n indicates the output voltage is less than desired, the control signal causes a power pulse to pass through the gating mux 440 and cycle the power switch Q1 in the following switching cycle n+1. Similarly, if the feedback signal 410 for switching cycle n indicates the output voltage is greater than desired, the control signal causes a sense pulse to cycle the power switch Q1 for switching cycle n+1.

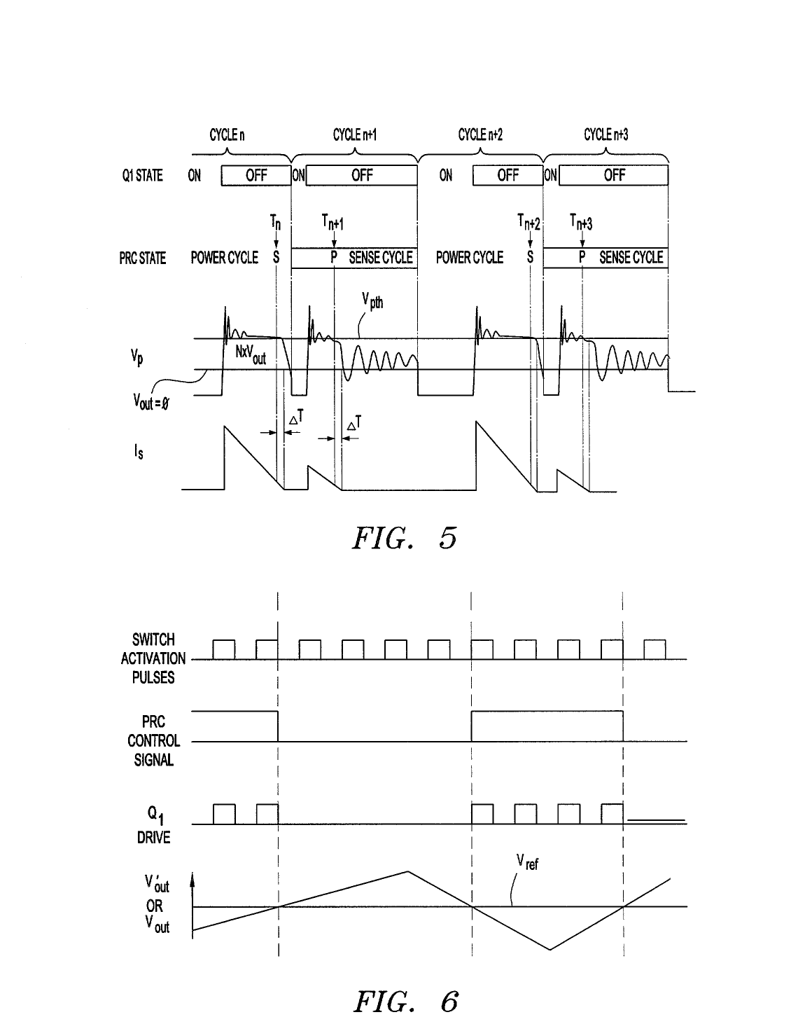

FIG. 5 illustrates how in a flyback converter embodiment of the power stage 405, the pulse rate controller 420 determines whether to allow a power pulse or sense pulse to cycle the power switch using primary-only feedback. The primary-side voltage, V_{P}, is measured at a selected sample time, t_{S}, on a positive cycle of an auxiliary winding on the primary-side ground plane. Based on the relationship V_{P}=N*V_{OUT}, where N is the turns ratio, the output voltage V_{OUT} at a sample time tₛₙ during the nth cycle is compared to a selected threshold V_{PTh}, e.g., through a binary comparator, to derive the feedback signal 410 for the next (n+1^{st}) cycle. If V_{P} is less than the threshold V_{PTh}, a power pulse follows in the n+1^{st} cycle. If V_{P} is greater than the threshold V_{PTh}, a sense pulse follows in the n +1^{st} cycle. By way of example, in FIG. 5, the primary voltage V_{P} for cycle n (at time tₛₙ) is greater than V_{PTh}; hence the decision by the pulse rate controller 420 to cause a sense pulse to cycle the power switch Q1 in cycle n+1.

To understand why the sample point t_{S} for each cycle is a true reflection of the output voltage, it is useful to examine the relationship between primary voltage V_{P} and output voltage V_{OUT}: V_{P}=(V_{OUT}′+ΔV) N_{P}/N_{S}, where V_{OUT}′+AV=V_{OUT}(ΔV representing the voltage drop across the secondary rectifying diode including parasitic losses), and N_{P}/N_{S}=N (turns ratio of the transformer), such that V_{P}=N*V_{OUT} Effective primary-only regulation of the output voltage is best achieved by sampling V_{P} in such a way that the value of ΔV is small enough to not impact the output regulation tolerance of the power supply, and is constant from sample to sample. The sample time t_{S} is preferably just before the secondary current I_{S} (across the rectifying diode) decays, and is also constant from sample to sample, in order to take the sample when V_{P} is relatively flat.

As will be appreciated, employing a counter in the pulse rate controller 420 allows the pulse control algorithm to take into account a history of previous pulses allowed to cycle the power switch Q1. The counter may hardware or software implemented. For example, a simple hardware counter can be employed to track a consecutive number of sense pulses that cycle the switch Q1. The counter is reset each time a power pulse is allowed to cycle the power switch. If more than a selected number of consecutive sense pulses cycle the switch Q1, it is presumed that the load demand is low or idle, which has placed the controller in a “sense mode.” At this point, the pulse rate control algorithm may implement pulsing patterns to further enhance efficiency of the power supply, such as periodically causing no pulse (power or sense) to cycle the power switch Q1.

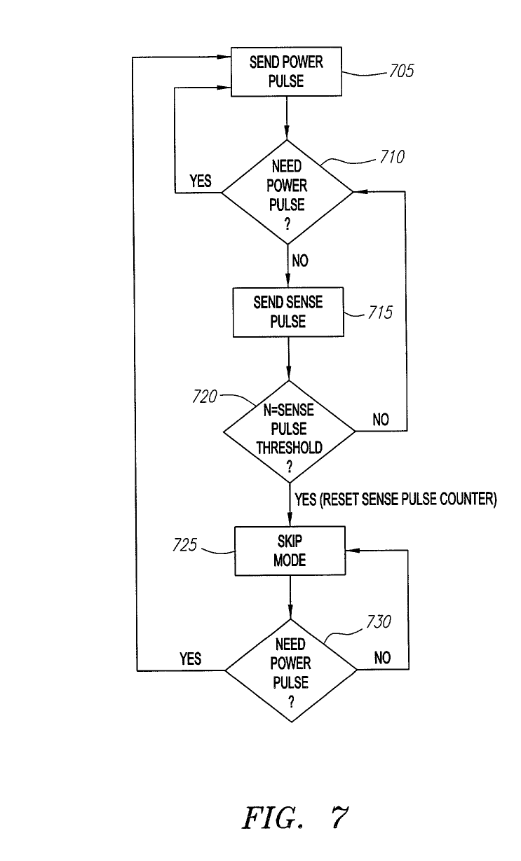

FIG. 7 is a flow chart illustrating such an embodiment utilizing a counter to track sense pulses. At a given switching cycle, the control signal from the pulse rate controller causes a power pulse to cycle the power switch, denoted as step 705). At step 710, prior to the time for initiating the next switching cycle, the pulse rate controller detects whether a power pulse is needed in the next switching cycle, (e.g., by detecting whether the feedback signal is low or high in order to determine whether the output voltage is lower or higher, respectively, than a desired output voltage). If another power pulse is needed, step 705 is repeated. If no power pulse is needed for the next switching cycle, a sense pulse is automatically sent to cycle the power switch for the switching cycle, denoted as step 715, and a counter in the pulse rate controller, which tracks a consecutive number of sense pulses, is incremented.

At step 720, if the number of consecutive sense pulses has not exceeded a predetermined threshold, step 710 is repeated. If a power pulse cycles the power switch prior to when the predetermined number of consecutive sense pulses is reached, the counter is reset to zero. If the predetermined number of consecutive sense pulses is reached before a power pulse is needed, the pulse rate controller changes to a “skip mode” of operation, and the counter is reset, denoted as step 725. In the skip mode of operation, a selected number of switching cycles are “skipped,” i.e., with “no pulse” sent to cycle the power switch.

As will be appreciated, various embodiments of a skip mode operation are possible. Of course, in embodiments using primary-only feedback, the length of a “skip cycle” (consecutive cycles with no sense or power pulse) must be limited to insure that the output voltage continues to be monitored, with the number of switching cycles between straw sense pulses being constant or incrementally changed. By utilizing the information obtained by sampling the primary-side voltage waveforms associated with the sense pulses at a precisely calculated sampling time in each cycle, the pulse rate controller deduces the appropriate inter-sense pulse period and schedules sense pulses accordingly. When the load reappears, logic similar to that used to detect the onset of the light or no load condition returns the controller to the normal mode of operation.

Where an operating supply V_{C} for powering the controller 400 is provided from the secondary of the power stage 405, e.g., from an auxiliary secondary transformer winding, the skip mode algorithm may also take the operating supply V_{C} into account. For example, if the operating supply V_{C} drops below a minimum safe operation threshold, the pulse rate controller 420 will change from skip mode back to a regular mode of operation and deliver one or more power pulses to the load, regardless of any other factors, so as to avoid a loss of the control function until the operating supply V_{C} is safely back above the minimum threshold.

A more complex set of counters can be used to track both sense and power pulses allowed to cycle the power switch Q1 over a recent number of switching cycles, and even the order, or concentration over time, that the respective pulses were delivered. Having such historical information allows for implementation of more sophisticated pulse control algorithms. For example, a pulse control algorithm could require that the feedback signal be low or high for a certain number of consecutive switching cycles before responding by sending a respective power or sense pulse.

Other inputs to the pulse rate control algorithm may also be desirable for increased flexibility in output regulation. For example, the control algorithm may also take into account the feedback signal 410 over a number of prior switching cycles, and not just the most immediately prior switching cycle, i.e., by using a further counter to track the feedback signal 410 following each switching cycle. For example, the pulse control algorithm may require two or more consecutive “low” feedback signals (indicating the output voltage V_{O} is less than a desired level for the same number of consecutive cycles), or that the feedback signal stay low for a certain concentration of previous cycles (e.g., four out of seven switching cycles), before causing a power pulse to cycle the power switch Q1. Likewise, the pulse control algorithm may require the feddback signal to remain high (indicating the output voltage V_{O} is greater than a desired level) for the same number of consecutive cycles, or that feedback signal remain high for a certain concentration of previous cycles (e.g., five out of eight switching cycles), before causing a sense (or “no”) pulse to cycle the power switch.

By way of further example, by correlating the actual input line voltage at each switching cycle with the specific power pulse, sense pulse, or “no” pulse, allowed to cycle the power switch, the precise power delivered to the load over the same time period can be determined and factored in the pulse control algorithm for more precisely regulating the total delivered power over time.

Pulse control algorithms may also be based, in total or in part, on factors other than output voltage regulation of changing load conditions, or varying input line voltage, e.g., due to battery discharge. For example, the control algorithm may be further based on one or more output power control inputs, such as a temperature, a time of day, a day of week, load balancing of parallel coupled converters, or output power consumption. For example, in one embodiment, a first pulse control algorithm based on output voltage regulation is overridden by a second pulse control algorithm based on load balancing of multiple power converters arranged in parallel for supplying power to a common load. In another embodiment, a first pulse control algorithm based on output voltage regulation is overridden by a second pulse control algorithm based on limiting the total output power supplied during a peak usage time-of-day, or due to a drop in the input line voltage.

Again, it will be appreciated that the particular functional circuit elements of the controller 400, i.e., feedback signal circuitry 410, pulse rate controller 420, pulse generators 430 and 435, and the gating mux 440, may be implemented in a single circuit, separate circuits, or circuits comprising sub-combinations thereof. For example, in one embodiment, the function of pulse generation and pulse gating may be combined, such that the pulse rate control algorithm dictates whether a power pulse, sense pulse, or no pulse, is generated for a given switching cycle. In this embodiment, no actual gating of the switch activation pulses is required. Further, the power switch Q1 may alternately be integral to the controller 400 instead of the power stage 405, separate from both, or included in a fully integrated power converter and control system. Thus, the circuit elements of the described embodiments are not to be restricted in the appended claims to require that the various circuit functions be provided by separate circuits.

Notably, the switch activation output by pulse generator 330 (FIG. 3), and the power and sense pulses output by pulse generators 430 and 435 (FIG. 4) are non-optimized. This is to say, there is no specific control mechanism for governing when in the switching cycle an activation pulse is generated, or for how long a respective pulse lasts (i.e., pulse width). In accordance with a general aspect of the invention, the timing and duration of the switch activation pulses are preferably “optimized” for best operational efficiency of the converter (generally defined as V_{OUT}/V_{IN}. These two control optimization concepts are separate in purpose and implementation.

First, it is desirable to optimize when in each switching activation cycle the power switch should be transitioned from OFF to ON, referred to herein as OFF TIME control, as it is a function of controlling how long to extend the power switch OFF TIME between activation pulses. OFF TIME control is directed generally to providing zero voltage transition of the power switch (typically a power MOSFET switch) under fully reset power transformer magnetic flux. Zero voltage switching is generally used to describe a condition for optimizing the time to trigger a next power pulse to be coincident with a close to zero switch drain voltage under zero transformer flux. This mode of operation may be referred to as a “quasi-resonant mode.” Operating at or near quasi-resonance increases operational efficiency of a power converter by reducing switching losses, reduces EMI emissions by eliminating high voltage/high current switching, and improves reliability by reducing component stress.

It is further desirable to optimize the duration the switch should remain ON during a given switching cycle before it is transitioned from ON to OFF, referred to herein as ON TIME control. ON TIME control is directed generally to maintaining a constant peak primary current, regardless of changes in input line voltage, in order to maintain constant power output.

Embodiments of the invention may incorporate one or both of OFF TIME and ON TIME control, but preferably incorporate both, thus providing a power converter controller for maintaining both zero voltage (quasi-resonant) switching and constant peak primary current over a wide range of input line and output load conditions using primary-only feedback.

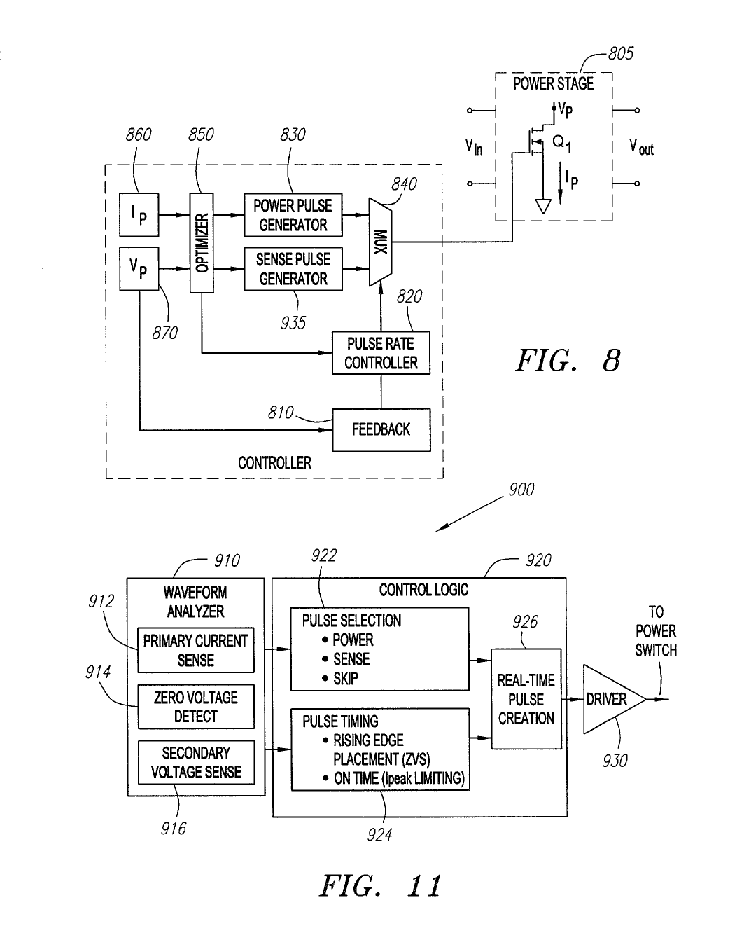

FIG. 8 illustrates a still further generic transformer-isolated power stage 805, which is preferably a flyback converter. The power stage 805 includes a MOSFET power switch Q1 having an activation gate that is cycled ON and OFF by a controller 800. The controller 800 includes a first pulse generator 830 for producing power pulses, and a second pulse generator 835 for producing sense pulses, respectively, for cycling the power switch Q2. The first and second pulse generators 830 and 835 produce the respective power and sense pulses at a same, relatively high frequency (e.g., 100 KHz to 1 MHz), with production of a respective pulse by the first and second pulse generators initiates a new switching cycle for the power stage 805. The power and sense pulses are input into a gating mux 840, where, for each switching cycle, a power pulse, sense pulse, or neither is allowed to cycle the power switch Q1, based on a control signal from a pulse rate controller 820 that is also input into gating mux 840.

As with controller 400 in the embodiment of FIG. 4, controller 800 of FIG. 8 provides digital output regulation of the power stage 805 by selectively allowing, on a pulse-by-pulse basis, a power pulse, sense pulse, or neither, to cycle the power switch Q1 based on a pulse control algorithm. Again, the pulse control algorithm may be hardware or software implemented in the pulse rate controller, e.g., by a simple or more complex state machine. Various embodiments of pulse control algorithms implemented by the pulse rate controller 820 are the same as described above in conjunction with pulse rate controller 420.

Controller 800 further includes pulse optimizing circuitry (“pulse optimizer”) 850 coupled to the respective first and second pulse generators 830 and 835. Based on inputs comprising sampled primary side current I_{P} 860 and sampled primary side voltage V_{P} 870 the pulse optimizer 850 optimizes the ON TIME and OFF TIME, respectively, of the power and sense pulses. The pulse optimizer 850 may be implemented by a combination of analog and digital circuitry and may include logic circuits, memory circuits, registers, and/or a processor needed to achieve the features/functions desired for controlling pulse generation of pulse generators 830 and 835. Embodiments of the pulse optimizer 850 may include software or firmware for achieving the desired features/functions.

In a preferred embodiment, the pulse optimizer 850 causes the first and second pulse generators 830 and 835 to generate respective power and sense pulses and initiate a new switching cycle a point when the primary side voltage is approximately zero, and converter losses are minimized.

In a preferred embodiment, the pulse optimizer 850 controls the ON time of power pulses in order to maintain constant peak primary current (and, thus, power output), regardless of changes in input line voltage. It should be emphasized that if the pulse optimizer 850 is configured for constant peak primary current control, the power pulse ON TIME will vary with changes in the input voltage, but will not change with respect to output voltage regulation, an important distinction from prior art PWM controllers.

In some embodiments, it may be desirable to configure the pulse optimizer to vary the peak primary current somewhat with wide changes in the input voltage. For example, in one embodiment, the selected peak current has a first value for a first range of input voltages, and a second value for a second range of input voltages. This “adaptive” approach still provides constant primary peak current control within defined ranges of input line voltage, but helps prevents the too wide of variations in the switching duty cycle.

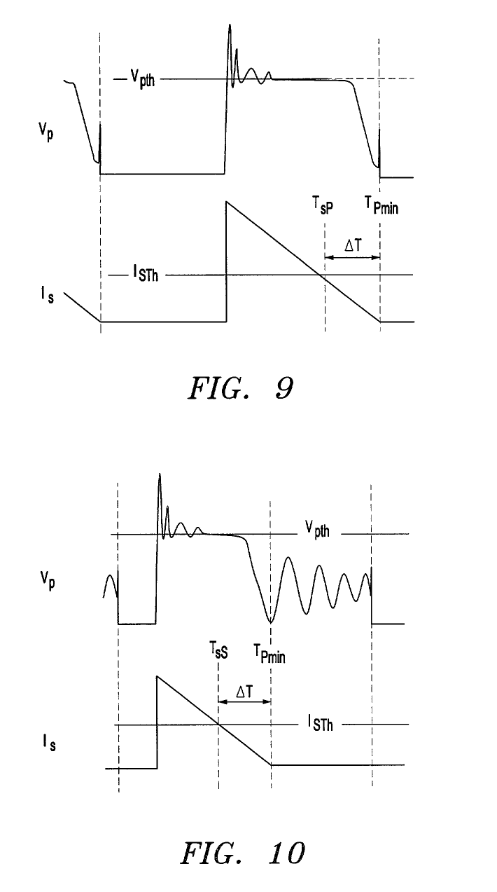

FIGS. 9 and 10 illustrate a timing algorithm for determining in a flyback converter embodiment when to initiate a new switching cycle to achieve quasi-resonant mode operation, respectively, which is based on the fact that the secondary current Is drops to zero at the time t_{Pmin} the primary voltage V_{P} achieves a first minimum after the power switch Q1 turns OFF. Notably, the rate of the secondary current drop is constant, pulse-to-pulse, whether the power switch Q1 has been cycled by a power pulse or a sense pulse. Estimating sampling times only requires extracting t_{Pmin} (i.e., “t_{P}P” for power pulses, and “t_{P}S” for sense pulses), and adjusting by a fixed advance time, ΔT. For optimum converter performance, the OFF TIME of the power pulses are set to achieve critically discontinuous operation. The pulse optimizer 850 calculates t_{Pmin} from V_{P}*(scaled equivalent of V_{P}), and passes t_{S}(as “t_{S}P” for power pulses, or “t_{S}S” for sense pulses) to the pulse rate controller for use in estimating the time needed to sample the binary comparator in the next switching cycle, power pulse or sense pulse, as the case may be. As for ON TIME optimization, the pulse optimizer 850 simply employs an algorithm to set the peak primary current to a constant value. This is accomplished by sampling the primary current and turning the power switch Q1 OFF when the peak current reaches the threshold value. The pulse optimizer 850, acting on the actual or a scaled equivalent of the primary current, then adjusts the ON TIME of power pulses to maintain a prescribed peak primary current.

Because neither ON TIME nor duty cycle of the power switch Q1 are used to regulate output voltage, the strategies of constant peak primary current and zero-current switch-on may be implemented without penalty to performance. The benefits of these strategies materialize in the form of improved efficiency and/or power density. For a given output power specification, constant peak primary current contributes to improved efficiency; critically discontinuous operation enables the use of a smaller transformer and thus contributes to improved power density as well as improved efficiency.

Once again, it will be appreciated that the particular functional circuit elements described in conjunction with controller 800, i.e., feedback signal circuit 810, pulse rate controller 820, pulse generators 830 and 835, gating mux 840, and the pulse optimizer 850, may be implemented in a single circuit, separate circuits, or circuits comprising sub-combinations thereof For example, in one embodiment, the function of pulse generation and pulse gating may be combined, such that the pulse rate control algorithm dictates whether a power pulse, sense pulse, or no pulse, is generated for a given switching cycle. In this embodiment, no actual gating of the respective power and sense pulses is required. Further, the power switch Q1 may alternately be integral to the controller 800 instead of the power stage 805, separate from both, or included in a fully integrated power converter and control system. Thus, the circuit elements are not to be restricted in the appended claims to require that the various functions be provided by separate circuit elements.

FIG. 11 illustrates a further embodiment of a digital controller 900 for regulating a transformer-isolated power converter using power and sense pulse optimization techniques. The controller 900 includes two main functional components: waveform analyzer 910 and pulse control logic 920. The waveforn analyzer 910 receives as inputs primary-side current 912 and primary-side voltage 914 for detecting ON TIME to peak primary current and OFF TIME to primary zero voltage, respectively. In one embodiment, primary voltage and current are both sampled at the input (drain) of the power switch Q1. In one embodiment, the waveform analyzer 910 also receives a sensed secondary voltage 916 input for generating a binary feedback signal corresponding to the output voltage level.

The waveform analyzer 910 uses the information contained in the reflected voltage to measure both secondary (output) voltage and transformer reset (zero-voltage) time on a real-time basis following each switch activation (power or sense) pulse. For example, where the controller 900 is used to control a flyback power converter, the reflected voltage seen during the power switch OFF TIME reveals not only the secondary voltage, but a great deal of additional information about the circuit, including leakage inductance, transformer reset time resonant frequency, and secondary diode characteristics. This information is easily read on the primary side of the transformer, or on an auxiliary secondary winding coupled to the primary ground plane. These distinctive voltage excursions take place during the secondary current decay to zero. When the secondary current reaches zero, the power transfer to the load is complete, and the transformer reset begins. This information is sufficient such that secondary feedback is unnecessary. Because the voltage reading is made at a very low secondary current, errors caused by IR drops are extremely small, and the diode drop is constrained to a narrow range. Real-time waveform analysis is, thus, the key to accurate primary-only regulation.

An additional advantage of the resonance at the end of the cycle is that amplitude of this waveform goes very close to zero. Zero-voltage switching is achieved by measuring the resonant period on a sense cycle, and switching the output transistor when the voltage is closest to zero on subsequent power cycles. On each power pulse switching cycle (“power cycle”), the waveform analyzer 910 waits for the voltage to drop below the input voltage, indicating the converter is in a critical conduction resonance.

The binary feedback signal is used by pulse selection circuitry 922 within the pulse control logic 920 for determining, based on a pulse control algorithm, whether to generate a power pulse, sense pulse, or no pulse, for a next switching cycle. The pulse selection circuitry 922 preferably includes a counter for tracking which, if any, pulse type was generated for a number of previous switching cycles. The ON TIME to-peak primary current and OFF TIME to zero voltage switching are used by pulse timing circuitry 924 in the pulse control logic 920 for generating the ensuing switch activation pulse, i.e., for timing the rising edge of the pulse based on zero-voltage switching conditions, and the width (ON TIME) the pulse based on pulse of based on peak primary current limiting (if a power pulse). In this manner, real-time waveform analysis is used to alter the pulse ON/OFF timing on a cycle-by-cycle basis.

The pulse type (if any) from the pulse selection circuitry 922 and the pulse timing (if applicable) from the pulse timing circuitry 924 are input into a real-time pulse generator 926. A generated power or sense pulse output from the pulse generator 926 is input into a driver 930 for cycling the power switch. In one embodiment, a sense cycle has the same period as a preceding power cycle, with the sense pulse ON TIME is set to one-fourth that of the preceding power pulse. In this embodiment, a sense cycle only transfers one-fourth as much energy as a power cycle. Under most load conditions, regulation is achieved through a mix of power cycles and sense cycles. Under extremely low-load conditions, no power pulses are sent to cycle the power switch. Instead, sense cycles are alternated with skip (“no pulse”) cycles.

Again, output voltage regulation does not depend on the width of the pulses. If the output voltage is lower than the desired level, the pulse selection circuitry 922 will send more power pulses in a row. If the output voltage is above the desired limit, the pulse selection circuitry 922 sends sense pulses instead of power pulses, until the output voltage drops. The pulse control algorithm implemented by the pulse selection circuitry 922 is not impacted or influenced by any change in the frequency or duty cycle of the power pulses. Whatever the shape and duration of the power pulses, the pulse selection circuitry 922 sends them when the output voltage is low, and replaces them with sense pulses when the output voltage is high.

By achieving zero-voltage switching, the controller 900 also achieves critically discontinuous conduction mode, because the power switch is turned back ON immediately after the transformer's magnetic field has reset. This eliminates dead time between switching cycles, fully utilizing the output transformer. Because the switching parameters are being analyzed in real time, compensation for variations in input line voltage and output load are made continuously. In addition, this method of extracting maximum performance from the inductor is insensitive to component variations, since the circuit behavior is actually measured, not assumed.

When power supply regulation is implemented as taught and described herein based on a binary feedback signal, the concept of “feedback loop bandwidth” is eliminated. The feedback voltage and current are neither filtered nor delayed in any conventional sense. The time between measurement and action is, at most, a fraction of a power cycle. The voltage measurement comes during the switch OFF TIME of every cycle, and controls the ON TIME switching decision for the next cycle. If the line voltage is very high, the current will ramp up quickly, and the power switch ON TIME will be short. If the input line voltage is very low, the current will ramp slowly, and the power switch ON TIME will be long.

Although particular embodiments of the invention have been shown and described, the invention is not limited to the preferred embodiments and it will be apparent to those killed in the art that various changes and modifications may be made without departing from the scope of the invention, which is defined only by the appended claims and their equivalents.

What is claimed:

1. A controller for controlling a power supply for conversion of power between a source and a load, the power supply including a power switch that, when coupled to the source and cycled ON and OFF, supplies a pulse of power to the load, the controller comprising:
pulse generation circuitry for generating switch activation pulses to cycle the power switch, each switch activation pulse produced by the pulse generator defining a new switching cycle; and
pulse optimization circuitry coupled to the pulse generation circuitry for controlling when a switch activation pulse is generated to initiate a switching cycle.

2. The controller of claim 1, wherein the pulse generation circuitry and the pulse optimization circuitry are implemented as a single circuit.

3. The controller of claim 1, wherein the pulse optimization circuitry causes a switch activation pulse to be generated to initiate a new switching cycle based on a primary side voltage condition.

4. The controller of claim 1, wherein the pulse optimization circuitry causes a switch activation pulse to be generated to initiate a new switching cycle when the primary side voltage is approximately zero.

5. The controller of claim 1, wherein the pulse optimization circuitry further controls a width of the switch activation pulses.

6. The controller of claim 5, wherein the pulse optimization circuitry determines the width of a switch activation pulse for a present switching cycle based on a primary side current during a previous switching cycle.

7. The controller of claim 5, wherein the pulse optimization circuitry determines the width of a switch activation pulse for a present switching cycle based on a power switch ON time needed to reach a primary side peak current during a previous switching cycle.

8. The controller of claim 7, the source having a variable input line voltage, wherein the primary side peak current is constant for all input voltages.

9. The controller of claim 7, the source having a variable input line voltage, wherein the primary side peak current varies in relation to the input voltage.

10. The controller of claim 9, wherein the primary side peak current has a first value for a first input voltage range, and a second value for a second input voltage range.

11. The controller of claim 1, further comprising pulse rate control circuitry coupled to the pulse generation circuitry for regulating an output voltage at the load by selectively allowing switch activation pulses to cycle the power switch.

12. The controller of claim 11, wherein the pulse generation circuitry, pulse optimization circuitry and pulse rate control circuitry are implemented as a single circuit.

13. The controller of claim 1, wherein the switch activation pulses include power pulses and sense pulses,
wherein the power switch, when cycled ON and OFF by a power pulse, supplies a substantial pulse of power to the load,
wherein the power switch, when cycled ON and OFF by a sense pulse, supplies an insubstantial pulse of power to the load, and
wherein the pulse optimization circuitry causes a power pulse or a sense pulse to be generated to initiate a new switching cycle based on a primary side voltage condition.

14. The controller of claim 13, wherein the pulse optimization circuitry causes a power pulse or a sense pulse to be generated to initiate a new switching cycle when the primary side voltage is approximately zero.

15. A controller for controlling a power supply for conversion of power between a source and a load, the power supply including a power switch that, when coupled to the source and cycled ON and OFF, supplies a pulse of power to the load, the controller comprising:
a first pulse generator for generating switch activation power pulses for cycling the power switch, wherein the power switch, when cycled ON and OFF by a power pulse, supplies a substantial pulse of power to the load;
a second pulse generator for generating switch activation sense pulses for cycling the power switch, wherein the power switch, when cycled ON and OFF by a sense pulse, supplies a an insubstantial pulse of power to the load;
the first and second pulse generators generating respective power and sense pulses at a same frequency, the production of a respective pulse by the first and second pulse generators defining a new switching cycle; and
pulse optimization circuitry coupled to the first and second pulse generators, the pulse optimization circuitry controlling when the first and second pulse generators generate respective power and sense pulses to initiate a switching cycle.

16. The controller of claim 15, wherein the pulse optimization circuitry is implemented in the respective first and second pulse generators.

17. The controller of claim 15, wherein the pulse optimization circuitry causes respective power and sense pulses to be generated to initiate a new switching cycle based on a primary side voltage condition.

18. The controller of claim 15, wherein the pulse optimization circuitry causes respective power and sense pulses to be generated to initiate a new switching cycle when the primary side voltage is approximately zero.

19. The controller of claim 15, wherein the pulse optimization circuitry further controls a width of the power pulses generated by the first pulse generator.

20. The controller of claim 19, wherein the pulse optimization circuitry determines a width of a power pulse for a present switching cycle based on a primary side current during a previous switching cycle.

21. The controller of claim 19, wherein the pulse optimization circuitry determines a width of a power pulse for a present switching cycle based on a power switch ON time needed to reach a primary side peak current during a previous switching cycle.

22. The controller of claim 21, the source having a variable input line voltage, wherein the primary side peak current is constant for all input voltages.

23. The controller of claim 21, the source having a variable input line voltage, wherein the primary side peak current varies in relation to the input voltage.

24. The controller of claim 23, the primary side peak current having a first value for a first input voltage range and a second value for a second input voltage range.

25. The controller of claim 15, further comprising pulse rate control circuitry coupled to the first and second pulse generators for regulating an output voltage at the load by selectively allowing, for each switching cycle, a power pulse, a sense pulse, or no pulse to cycle the power switch.

26. A power supply for conversion of power between a source and a load, comprising:
a power switch that, when coupled to the source and cycled ON and OFF, supplies a pulse of power to the load;
pulse generation circuitry for generating switch activation pulses to cycle the power switch, each switch activation pulse produced by the pulse generator defining a new switching cycle; and
pulse optimization circuitry coupled to the pulse generation circuitry for controlling when a switch activation pulse is generated to initiate a switching cycle.

27. The power supply of claim 26, wherein the pulse generation circuitry and the pulse optimization circuitry are implemented as a single circuit.

28. The power supply of claim 26, wherein the pulse optimization circuitry causes a switch activation pulse to be generated to initiate a new switching cycle based on a primary side voltage condition.

29. The power supply of claim 26, wherein the pulse optimization circuitry determines a width of a switch activation pulse for a present switching cycle based on a power switch ON time needed to reach a primary side peak current during a previous switching cycle.

30. The power supply of claim 26, wherein the switch activation pulses include power pulses and sense pulses,
wherein the power switch, when cycled ON and OFF by a power pulse, supplies a substantial pulse of power to the load,
wherein the power switch, when cycled ON and OFF by a sense pulse, supplies an insubstantial pulse of power to the load, and
wherein the pulse optimization circuitry causes a power pulse or a sense pulse to be generated to initiate a new switching cycle based on a primary side voltage condition.

31. The power supply of claim 30, wherein the pulse optimization circuitry causes a power pulse or a sense pulse to be generated to initiate a new switching cycle when the primary side voltage is approximately zero.

32. The power supply of claim 26, further comprising pulse rate control circuitry coupled to the pulse generation circuitry for regulating an output voltage at the load by selectively allowing switch activation pulses to cycle the power switch.

33. A power supply for controlling a power supply for conversion of power between a source and a load, comprising:
a power switch that, when coupled to the source and cycled ON and OFF, supplies a pulse of power to the load;
a first pulse generator for generating switch activation power pulses for cycling the power switch, wherein the power switch, when cycled ON and OFF by a power pulse, supplies a substantial pulse of power to the load;
a second pulse generator for generating switch activation sense pulses for cycling the power switch, wherein the power switch, when cycled ON and OFF by a sense pulse, supplies a an insubstantial pulse of power to the load;
the first and second pulse generators generating respective power and sense pulses at a same frequency, the production of a respective pulse by the first and second pulse generators defining a new switching cycle; and
pulse optimization circuitry coupled to the first and second pulse generators, the pulse optimization circuitry controlling when the first and second pulse generators generate respective power and sense pulses to initiate a switching cycle.

34. The power supply of claim 33, wherein the pulse optimization circuitry determines a width of a power pulse for a present switching cycle based on a power switch ON time needed to reach a primary side peak current during a previous switching cycle.
